(19) United States
(12) Patent Application Publication
(10) Pub. No.: US 2009/0211673 A1
(43) Pub. Date: Aug. 27, 2009

(54) DECORATIVE GRILL COVERS

(75) Inventor: Daniel Rupert Neren, White Bear Lake, MN (US)

Correspondence Address: CAMPBELL NELSON WHIPPS, LLC;HISTORIC HAMM BUILDING, 408 ST. PETER STREET, SUITE 240, ST. PAUL, MN, 55102, US

(73) Assignee: Daniel Rupert Neren, White Bear Lake, MN (US)

(21) Appl. No.: 12/035,875

(22) Filed: Feb. 22, 2008

(51) Int. Cl. B65D 65/02; A47J 37/07

(52) U.S. Cl. 150/165; 150/154

(57) ABSTRACT

Decorative grill covers and collections of grill covers, the decorative grill covers including indicia thereon. In a collection of grill covers, a plurality of grill covers are included, each of the grill covers having decorative indicia thereon, with the indicia on a first grill cover being related to, yet different than, the indicia on a second grill cover. In some embodiments, the decorative grill cover has a nature scene or other depiction of the environment thereon. A collection of grill covers may, for example, illustrate the changing seasons.

### BACKGROUND OF THE INVENTION

The present invention is directed to decorative grill covers. More particularly, the present invention is directed to grill covers having an image thereon that blends with the environment in which the grill is placed.

One of the most favored pastimes of Americans is cooking outside (i.e., bar-b-queuing). One could say that bar-b-queuing is a national pastime.

Almost every home in the U.S. has an outdoor grill of some type, either a small charcoal hibachi, a classical round Weber® grill, a standard dual control gas grill, a thousand dollar six burner built-in grill, or anything in between. For many households, it is impractical to move the grill after use to an indoor or covered storage location. Thus, many grills sit outside in the elements when not in use.

To protect these grills, covers are used. For many grills, the cover is a flexible plastic cover, usually black. Occasionally, a decorative cover may be used.

### SUMMARY OF THE INVENTION

The present invention is directed to decorative grill covers and to collections of grill covers. The decorative grill covers include indicia thereon. In a collection of grill covers, a plurality of grill covers are included, each of the grill covers having decorative indicia thereon, with the indicia on a first grill cover being related to, yet different than, the indicia on a second grill cover.

In some embodiments, the decorative grill cover has a nature scene or other depiction of the environment thereon.

In one particular aspect, this disclosure is directed to a decorative grill cover comprising a grill cover having decorative indicia on at least one surface, the decorative indicia depicting a nature scene. The nature scene could be at least one of a tree, a body of water, a garden, a plant, or multiples of any of these. The nature scene could also include at least one person and/or at least one animal.

In another particular aspect, this disclosure is directed to a collection of decorative grill covers, the collection comprising a first grill cover having decorative indicia on at least one surface, the decorative indicia depicting a first scene and a second grill cover having decorative indicia on at least one surface, with the decorative indicia depicting a second scene different from yet related to the first scene. The collection could further include a third grill cover having decorative indicia on at least one surface, the decorative indicia depicting a third scene different from yet related to the first scene and the second scene. Yet further, the collection could include a fourth grill cover having decorative indicia on at least one surface, the decorative indicia depicting a fourth scene different from yet related to the first scene, the second scene and the third scene. Any of the scenes could be nature scenes. For example, if four scenes are present, the scenes could represent different seasons.

In general, the decorative grill covers of this invention enhance the surroundings of the grill's location.

### BRIEF DESCRIPTION OF THE DRAWINGS

FIG. 1 is a perspective view of a grill having a generic cover thereon.

FIG. 2 is a perspective view of a grill having a decorative cover thereon.

FIG. 3 is a front plan view of a first grill cover from a collection of decorative grill covers.

FIG. 4 is a front plan view of a second grill cover from a collection of decorative grill covers.

FIG. 5 is a front plan view of a third grill cover from a collection of decorative grill covers.

FIG. 6 is a front plan view of a fourth grill cover from a collection of decorative grill covers.

FIG. 7 is a front plan view of a first grill cover from a second collection of decorative grill covers.

FIG. 8 is a front plan view of a second grill cover from a second collection of decorative grill covers.

FIG. 9 is a front plan view of a third grill cover from a second collection of decorative grill covers.

FIG. 10 is a front plan view of a fourth grill cover from a second collection of decorative grill covers.

### DETAILED DESCRIPTION OF THE PREFERRED EMBODIMENT

A variety of decorative grill covers and collections of decorative grills covers are disclosed in this application. Decorative grill covers include decorative indicia thereon. In a collection of grill covers, a plurality of grill covers are included, each of the grill covers having decorative indicia thereon, with the indicia on a first grill cover being related to, yet different than, the indicia on a second grill cover. Typically, the grill covers have a nature scene or other depiction of the environment thereon.

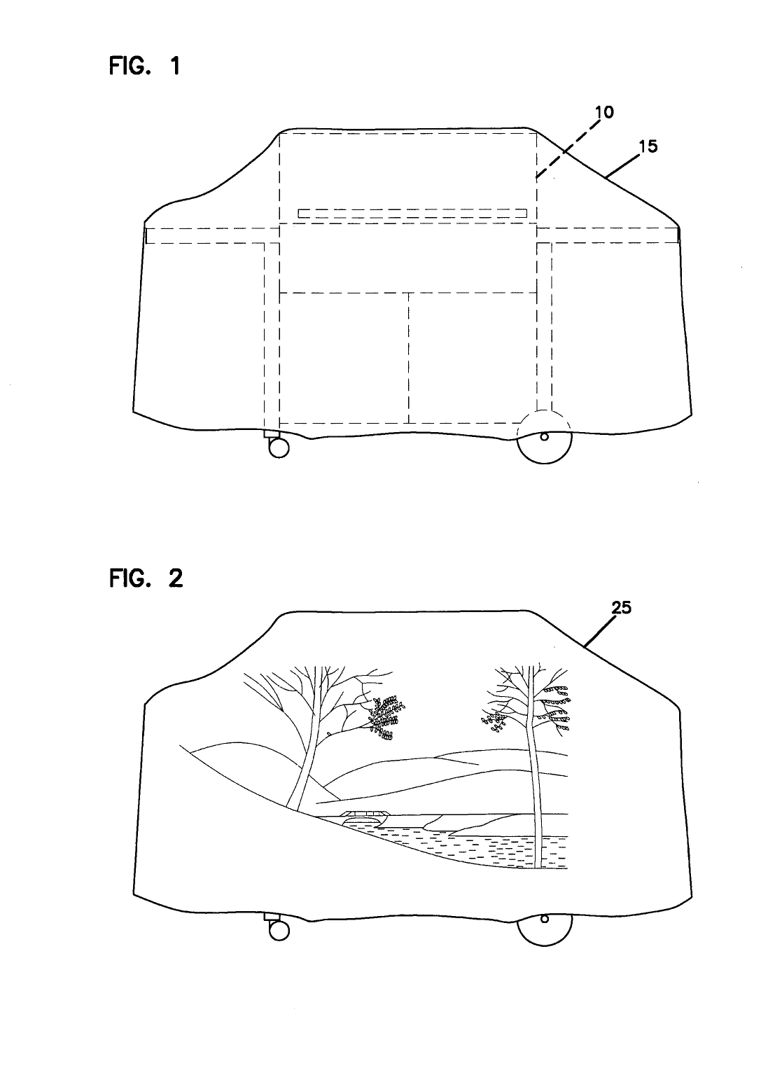

Referring now to the figures, particularly to FIG. 1, a grill 10 is shown having a generic cover 15 thereon. This grill cover 15 is a flexible sheet material, configured to fit over a grill. The particular grill 10 illustrated is a gas grill, for example, 25,000 BTU with dual controls. It is understood that grill covers according to this disclosure could be configured for other shapes and sizes of grills.

Grill cover 15 is flexible, typically made from a weather resistant material, such as a plastic sheet material. Most grill covers are water proof. Grill cover 15 may alternately be a laminate of cloth and plastic. In alternate embodiments, the grill cover may be a rigid or semi-rigid plastic material, such as polypropylene, polyethylene or polycarbonate.

Whether grill cover 15 is flexible, rigid or semi-rigid, grill cover 15 has at least one surface for receiving decorative indicia thereon. In some embodiments, multiple surfaces of the grill cover have decorative indicia thereon. For example, the front and back of the grill cover may have decorative indicia thereon. As another example, the front and two sides may have decorative indicia thereon.

Grill 10 is illustrated in FIG. 2 having a decorative grill cover 25 thereon. Grill cover 25 has indicia thereon that depict a nature scene. The particular cover 25 illustrates nature scene having a hilly topography with a waterway (e.g., a lake or river) in the valley. A bridge crosses over the waterway. In the foreground, two trees are illustrated.

Examples of other nature-type scenes suitable for inclusion on a grill cover include scenes that include trees or forests, bodies of water or waterways such as streams, rivers, ponds or lakes, waterfalls, flower gardens or vegetable gardens, plants such as flowers or bushes, meadows of grass and/or flowers, farm fields, hay stacks, and other scenic renderings. Topography or landscapes such as mountains, hills, canyons, gorges, meadows, and fields can be shown. People and/or animals may be included in the scenes.

In some embodiments, it is desired to have the grill blend in with the surroundings. For example, if the grill is located with a flower garden behind it, a grill cover having flowers thereon could be used to cover the grill.

In some embodiments, it is desired that the grill cover has a scene that mirrors or is similar to the grill surroundings. For example, if the grill is located in the mountains, it would be desirable to have a grill cover that is similar to the surrounding features, e.g. the cover includes snow covered mountain peaks and waterfalls. As another example, if the grill is located in a suburban neighborhood, it would desirable to have a grill cover that has, e.g., trees and flowers, or, e.g., a playground with children playing.

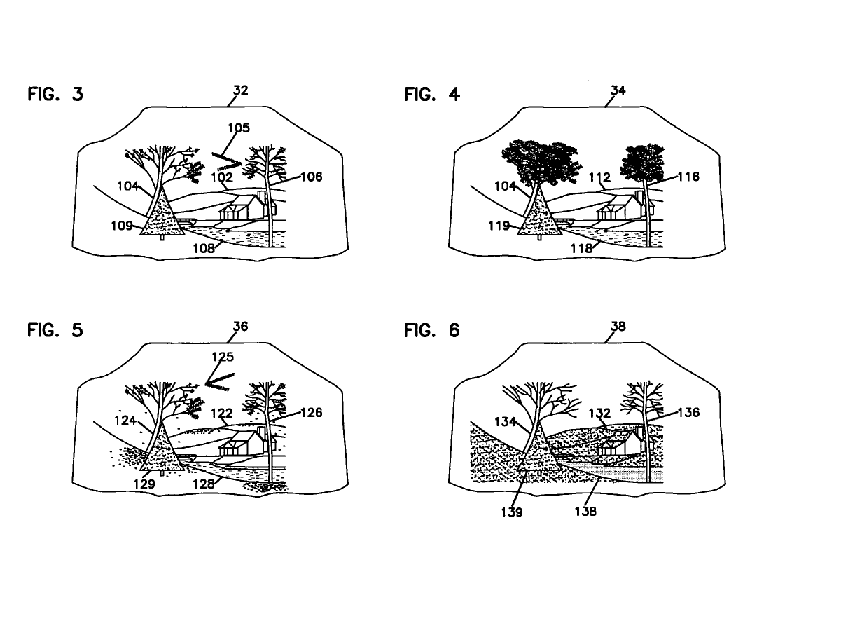

In FIGS. 3 through 6, a first embodiment of a collection of grill covers is shown. This collection includes a first grill cover 32 (FIG. 3), a second grill cover 34 (FIG. 4), a third grill cover 36 (FIG. 5), and a fourth grill cover 38 (FIG. 6), each of which is different, yet related to, each other. It is understood that a collection could have two, three, four, or more different yet related grill covers.

Because the covered grill generally sits outside in the elements, an object of a collection can be to be able to change the grill cover with the changing seasons.

This collection of grill covers in FIGS. 3 through 6 has a nature scene theme, with each of the grill covers having a certain setting shown in the four seasons. Specifically, grill cover 32 has a spring scene, grill cover 34 has a summer scene, grill cover 36 has a fall scene, and grill cover 38 has a winter scene.

In each of the grill covers, the scene is one of rolling hills topography with a stream, a house by the stream, two deciduous trees and one evergreen tree.

In FIG. 3, the spring scene, grill cover 32 has a hilly grassy countryside 102, a first deciduous tree 104 having emerging leaves, a second deciduous tree 106 having emerging leaves, water 108, and an evergreen tree 109. Additionally, a flock of birds 105 is shown flying north. In FIG. 4, the summer scene, grill cover 34 has a hilly grassy countryside 112, a first deciduous tree 114 having fully developed leaves, a second deciduous tree 116 having fully developed leaves, water 118, and an evergreen tree 119. In FIG. 5, the autumn or fall scene, grill cover 36 has a hilly grassy countryside 122, a first deciduous tree 124 having many fallen leaves, a second deciduous tree 126 having many fallen leaves, water 128, and an evergreen tree 129. Additionally, a flock of birds 125 is shown flying south. In FIG. 6, the winter scene, grill cover 38 has a snow covered hilly countryside 132, a first bare deciduous tree 134s, a second bare deciduous tree 136, ice 138, and an evergreen tree 139.

As can be seen, various elements in the scenes change with the changing seasons. However, in the spring, summer and fall scenes, the water remains unchanged, and in all of the four scenes, the evergreen trees remains unchanged. As can be seen, the scenes can include elements or items that are not found in every scene, although at least some elements are found in all the scenes.

Examples of other different yet related scenes, which would qualify as a collection include: scenes from a baseball game, having e.g., runners in different base positions or different halves of the inning or different innings of the game; scenes from a state, county or other fair, amusement park, or carnival showing, e.g., different rides, food booths, game stands or booths, and animal and/or craft exhibitions; and scenes having, e.g., a lake and its surroundings, as they change during the seasons (e.g., sailing or boating in the summer, ice skating in the winter). It is to be understood that although some examples of environments and atmospheres have been provided, other different yet related scenes would form a collection.

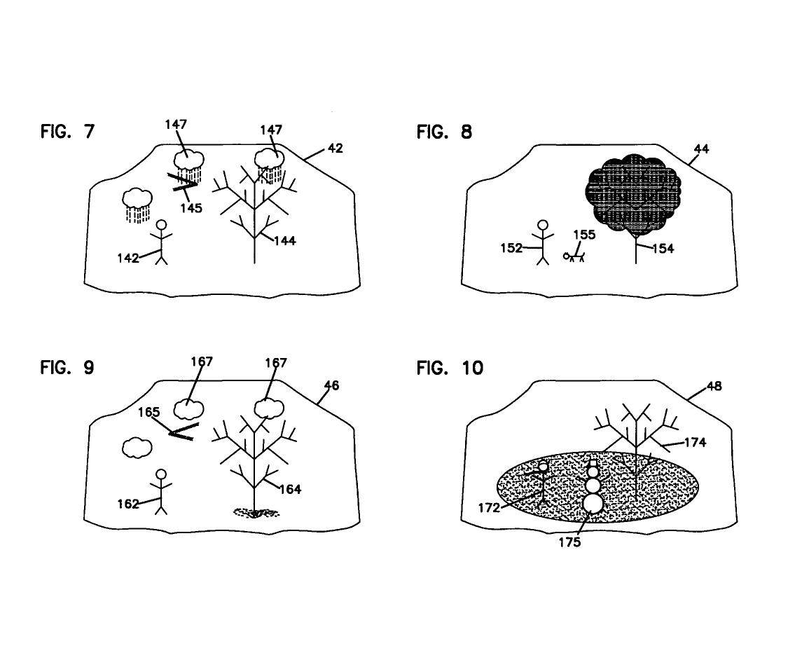

Another collection of grill covers is illustrated in FIGS. 7 through 10. Similar to the collection of FIG. 3 though 6, this collection of grill covers in FIGS. 3 through 6 has a nature scene theme, with each of the grill covers having a certain setting shown in the four seasons, but in this collection, the decorative indicia is illustrated in a manner as if drawn by a child or young adolescent; i.e., the figures are “stick” figures.

In each of the grill covers, the scene is one of a “stick” person and a “stick” tree. Specifically, grill cover 42 has a spring scene, grill cover 44 has a summer scene, grill cover 46 has a fall scene, and grill cover 48 has a winter scene.

In FIG. 7, the spring scene, grill cover 42 has a person 142 and a deciduous tree 144 with no leaves. A flock of birds 145 is shown flying north among rain clouds 147. In FIG. 8, the summer scene, grill cover 44 has a person 152 and a deciduous tree 154 fully leafed out. A dog 155 is illustrated with person 152. In FIG. 9, the fall or autumn scene, grill cover 46 has a person 162 and a deciduous tree 164 with fallen leaves. A flock of birds 165 is shown flying south among clouds 167. In FIG. 10, the winter scene, grill cover 48 has a person 172 and a deciduous tree 174 with no leaves. Person 172 has built a snowman 175. As can be seen, the scenes can include elements or items that are not found in every scene, although at least some elements are included in all the scenes.

The collections of grill covers (e.g., the collection having grill covers 32, 34, 36, 38 or 42, 44, 46, 48) could be packaged, marketing and/or sold as a collection or kit.

The above specification, examples and data provide a complete description of the manufacture and use of the composition of the invention. Since many embodiments of the invention can be made without departing from the spirit and scope of the invention, the invention resides in the claims hereinafter appended.

I claim:

1. A decorative grill cover comprising:
a grill cover having decorative indicia on at least one surface, the decorative indicia depicting a nature scene.

2. The decorative grill cover of claim 1, wherein the nature scene comprises at least one of a tree, a body of water, a garden, or a plant.

3. The decorative grill cover of claim 2, wherein the nature scene further includes at least one person.

4. The decorative grill cover of claim 2, wherein the nature scene further includes at least one animal.

5. A collection of decorative grill covers, the collection comprising:
a first grill cover having decorative indicia on at least one surface, the decorative indicia depicting a first scene; and
a second grill cover having decorative indicia on at least one surface, the decorative indicia depicting a second scene different from yet related to the first scene.

6. The collection of claim 5, further comprising a third grill cover having decorative indicia on at least one surface, the decorative indicia depicting a third scene different from yet related to the first scene and the second scene.

7. The collection of claim 6, further comprising a fourth grill cover having decorative indicia on at least one surface, the decorative indicia depicting a fourth scene different from yet related to the first scene, the second scene and the third scene.

8. The collection of claim 7, wherein the first scene, second scene, third scene, and fourth scene represent different seasons.

9. The collection of claim 5, wherein the first scene and the second scene are nature scenes.

10. The collection of claim 5, wherein the first scene and the second scene are scenes of a fair, carnival, or amusement park.
